(19) United States
(12) Patent Application Publication
(10) Pub. No.: US 2004/0094187 A1
(43) Pub. Date: May 20, 2004

(54) Apparatus and method for holding a semiconductor wafer using centrifugal force

(76) Inventor: Yong Ho Lee, Fremont, CA (US)

Correspondence Address: Wilson & Ham, PMB: 348, 2530 Berryessa Road, San Jose, CA, 95132, US

(21) Appl. No.: 10/295,537

(22) Filed: Nov. 15, 2002

(51) Int. Cl. B08B 3/00; B08B 7/00

(52) U.S. Cl. 134/33; 134/137; 134/164

(57) ABSTRACT

An apparatus and method for holding a semiconductor wafer utilizes confining members having a wafer engaging end to both support and confine the semiconductor wafer using centrifugal force when the wafer and the confining members are being rotated about a rotational axis. The confining members may be configured to be pivoted when subjected to centrifugal force caused by the rotation of the confining members such that pressure is applied on the wafer edge by the wafer engaging end of each confining member in a radial direction toward the rotational axis when the confining members are pivoted.

### FIELD OF THE INVENTION

The invention relates generally to semiconductor fabrication processing, and more particularly to an apparatus and method for holding a semiconductor wafer.

### BACKGROUND OF THE INVENTION

As semiconductor devices are aggressively scaled down, the number of photoresist masking steps used in the photolithography process has significantly increased due to various etching and/or implanting requirements. Consequently, the number of post-masking cleaning steps has also increased. After a layer of photoresist is patterned on a semiconductor wafer and then subjected to a fabrication process, such as plasma etch or ion implantation, the patterned photoresist layer must be removed without leaving photoresist residue, which may detrimentally affect the resulting semiconductor device with respect to performance and reliability.

Traditionally, semiconductor wafers have been cleaned in batches by sequentially immersing the wafers into baths of different cleaning fluids, i.e., wet benches. However, with the advent of sub-0.18 micron geometries and 300 mm wafer processing, the use of batch cleaning has increased the potential for defective semiconductor devices due to cross-contamination and residual contamination. In order to mitigate the shortcomings of batch cleaning processes, single-wafer spin-type cleaning techniques have been developed. Conventional single-wafer spin-type cleaning systems typically include a single fluid deliver line to dispense one or more cleaning fluids, such as de-ionized water, standard clean 1 (SC1) solution and standard clean 2 (SC2) solution, onto a surface of semiconductor wafer in an enclosed environment. After the semiconductor wafer is cleaned, the wafer is usually rinsed and then spin-dried by rotating the wafer at a high rotational speed and applying gas and/or vapor onto the wafer.

An important component of a single-wafer spin-type cleaning system is the wafer holding apparatus that holds a semiconductor wafer during cleaning, rinsing and/or spin-drying. Since the semiconductor wafer may be rotated at high speeds, the wafer holding apparatus should be designed to securely hold the wafer, especially while the wafer is rotating at a high speed. However, the need to securely hold the semiconductor wafer must be balanced against the fragility of the wafer. Application of unnecessary strong forces on a semiconductor wafer may damage or break the fragile wafer. In addition, the wafer holding apparatus should be designed so that both sides of the semiconductor wafer can be accessed, which allows both sides of the wafer to be cleaned using one or more cleaning fluids, such as deionized water.

Some conventional wafer holding apparatuses do not allow access to both sides of a semiconductor wafer being processed. Thus, these wafer holding apparatuses allow only one side of the semiconductor wafer to be cleaned. Other conventional wafer holding apparatuses do allow access to both sides of a semiconductor wafer so that the wafer can be cleaned on both sides. However, in general, these wafer holding apparatuses are mechanically complex and require many moving parts. Therefore, these conventional wafer holding apparatuses are difficult to manufacture and are more prone to mechanical malfunctions.

In view of the above-described concerns, there is a need for an apparatus and method for holding a semiconductor wafer using minimal moving parts such that both sides of the wafer can be accessed for cleaning without subjecting the wafer to unnecessary strong forces.

### SUMMARY OF THE INVENTION

An apparatus and method for holding a semiconductor wafer utilizes confining members having a wafer engaging end to both support and confine the semiconductor wafer using centrifugal force when the wafer and the confining members are being rotated about a rotational axis. The confining members may be configured to be pivoted when subjected to centrifugal force caused by the rotation of the confining members such that pressure is applied on the wafer edge by the wafer engaging end of each confining member in a radial direction toward the rotational axis when the confining members are pivoted.

An apparatus for holding an object in accordance with an exemplary embodiment of the invention includes a support structure, a rotational drive mechanism and a number of confining assemblies. The rotational drive mechanism is operatively connected to the support structure to rotate the support structure about a rotational axis. The confining assemblies are attached to the support structure. Each confining assembly includes a confining member having an object engaging end that is configured to support the object. Each confining assembly is configured to apply pressure on an edge of the object in a radial direction toward the rotational axis with the object engaging end when subjected to centrifugal force caused by the rotation of the support structure.

A method for holding an object in accordance with an exemplary embodiment of the invention includes the steps of placing the object on object engaging ends of confining members of an object holding apparatus, rotating the confining members about a rotational axis, and confining the object with the object engaging ends of the confining members using centrifugal force caused by the rotation of the confining members such that the object is held by the engaging ends of the confining member.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a single-wafer spin type cleaning system that includes a wafer holding apparatus in accordance with an exemplary embodiment of the present invention.

FIG. 2 is a top view of the wafer holding apparatus with a semiconductor wafer.

FIG. 3 is a top view of the wafer holding apparatus without the semiconductor wafer.

FIG. 4 is a cross-sectional view of the wafer holding apparatus.

FIG. 5 is another cross-sectional view of the wafer holding apparatus.

FIG. 6 illustrates the external side of a confining assembly of the wafer holding apparatus.

FIG. 7 illustrates the interior side of the confining assembly of FIG. 6.

FIG. 8 illustrates a lateral side of the confining assembly of FIG. 6.

FIG. 9 illustrates the wafer engaging end of the confining member of the confining assembly of FIG. 6.

FIG. 10 is a flow diagram of the overall operation of the single-wafer spin-type cleaning system of FIG. 1.

FIG. 11 is a flow diagram of a method of holding a semiconductor wafer in accordance with an exemplary embodiment of the invention.

### DETAILED DESCRIPTION

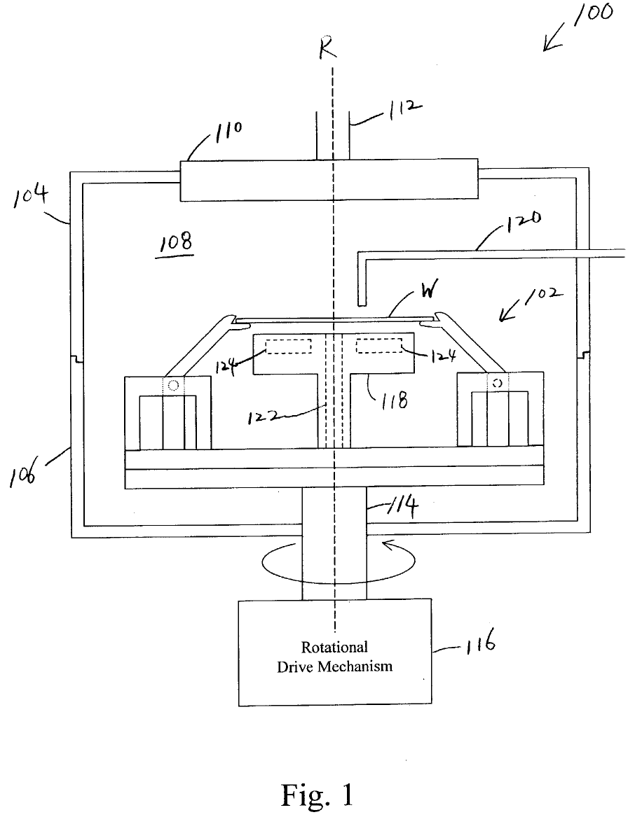

With reference to FIG. 1, a single-wafer spin-type cleaning system 100 is shown. The cleaning system 100 includes a wafer holding apparatus 102 in accordance with an exemplary embodiment of the invention. The wafer holding apparatus 102 is designed to securely hold a rotating semiconductor wafer W by confining the edge of the wafer using centrifugal force so that both surfaces of the wafer, i.e., the front side (upper surface) and the backside (lower surface), can be accessed for cleaning using one or more cleaning fluids. The use of centrifugal force allows the wafer holding apparatus 102 to securely hold the semiconductor wafer when the wafer is rotated at a high rate of speed. Thus, the wafer holding apparatus 102 selectively applies more pressure on the semiconductor wafer edge when the wafer needs to be held more securely. Furthermore, the wafer holding apparatus 102 has a non-complex configuration with minimal moving parts so that the apparatus can be easily manufactured and is less prone to mechanical malfunctions.

As shown in FIG. 1, the single-wafer spin-type cleaning system 100 includes an upper enclosure structure 104 and a lower enclosure structure 106, which provide an enclosed cleaning chamber 108 when the upper and lower structures are closed. The upper enclosure structure 104 is designed to be raised by a lifting mechanism (not shown) so that the cleaning chamber 108 can be opened, which allows semiconductor wafers to be transferred into and out of the cleaning chamber. Attached to the upper enclosure structure 104 is an environmental gas supply assembly 110, which is connected to a gas supply line 112. The environmental gas supply assembly 110 provides clean environmental gas, such as N₂ or air, into the enclosed cleaning chamber 108. The environmental gas is received at the environmental gas supply assembly 110 from a supply of environmental gas (not shown) through the gas supply line 112.

The cleaning system 100 further includes a rotation shaft 114, a rotational drive mechanism 116, a backside cleaning structure 118 and a fluid supply line 120. The rotational shaft 114 is attached to wafer holding apparatus 102 and the rotational drive mechanism 116. The rotational drive mechanism 116 operates to rotate the wafer holding apparatus 102 via the rotating shaft 114. However, in the exemplary embodiment, the backside cleaning structure 118 is not rotated by the rotational drive mechanism 116. Thus, the backside cleaning structure 118 remains stationary while the wafer holding apparatus 102 and the rotating shaft 114 are rotated.

The fluid supply line 120 is used to supply one or more cleaning fluids onto the front side of the semiconductor wafer W. These cleaning fluids may include the following fluids: de-ionized water, diluted HF, mixture of NH₄OH and H₂O, standard clean 1 or “SC1” (mixture of NH₄OH, H₂O₂ and H₂O), standard clean 2 or “SC2” (mixture of HCl, H₂O₂ and H₂O), ozonated water (de-ionized water with dissolved ozone), modified SC1 (mixture of NH₄OH and H₂O with ozone), modified SC2 (mixture of HCl and H₂O with ozone), known cleaning solvents (e.g., a hydroxyl amine based solvent EKC265, available from EKC technology, Inc.), or any constituent of these fluids. The fluid supply line 120 is connected to a supply of cleaning fluids (not shown). Although the single-wafer spin-type system 100 is illustrated and described as having a single fluid supply line, the system may include additional fluid supply lines to supply one or more cleaning fluids to different areas of the semiconductor wafer front side.

Similarly, the backside cleaning structure 118 is also used to supply one or more cleaning fluids to the backside of the semiconductor wafer W. The backside cleaning structure 118 includes a fluid supply conduit 122 to route one or more cleaning fluids to the backside of the semiconductor wafer through the backside cleaning structure. The cleaning fluids supplied to the backside of the semiconductor wafer can be used to clean and/or rinse the backside of the wafer to ensure that the backside does not become contaminated during the cleaning process. The fluid supply conduit 122 of the backside cleaning structure 118 may be connected to the same supply of cleaning fluids as the fluid supply line 120. Alternatively, the fluid supply conduit 122 may be connected to a different supply of cleaning fluids. Although the backside cleaning structure 118 is illustrated and described as having a single fluid supply conduit, the backside cleaning structure may include additional fluid supply conduits to supply one or more cleaning fluids to different areas of the semiconductor wafer backside. The backside cleaning structure 118 may include one or more acoustic transducers 124 to generate acoustic energy to assist in the cleaning of the semiconductor wafer. The acoustic energy generated by the acoustic transducers 124 may be ultrasonic or megasonic.

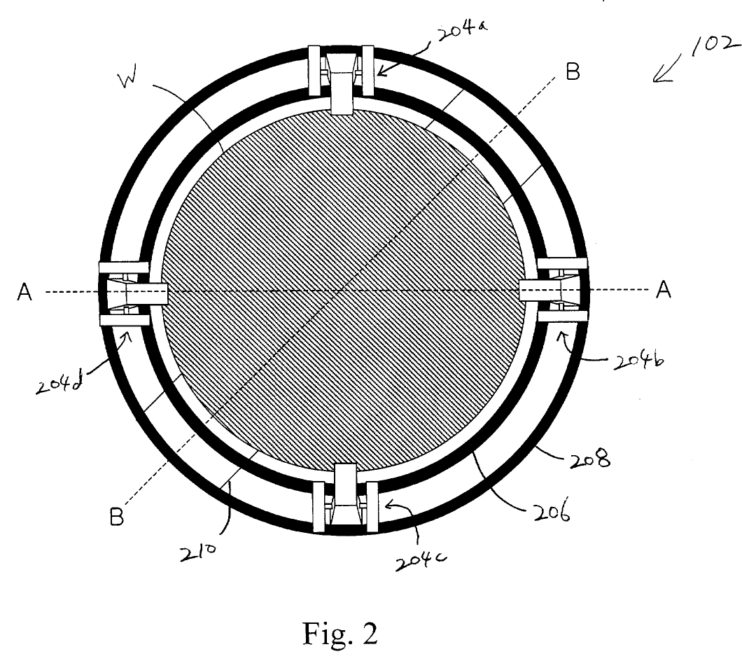

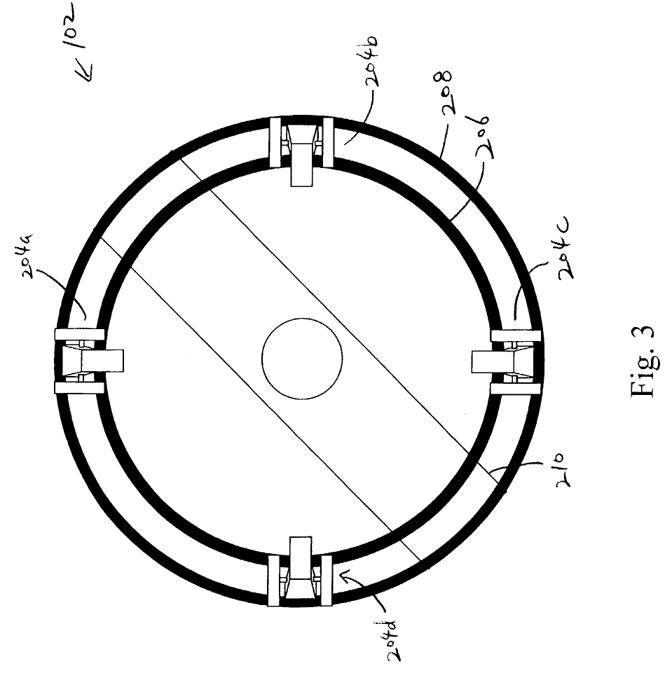

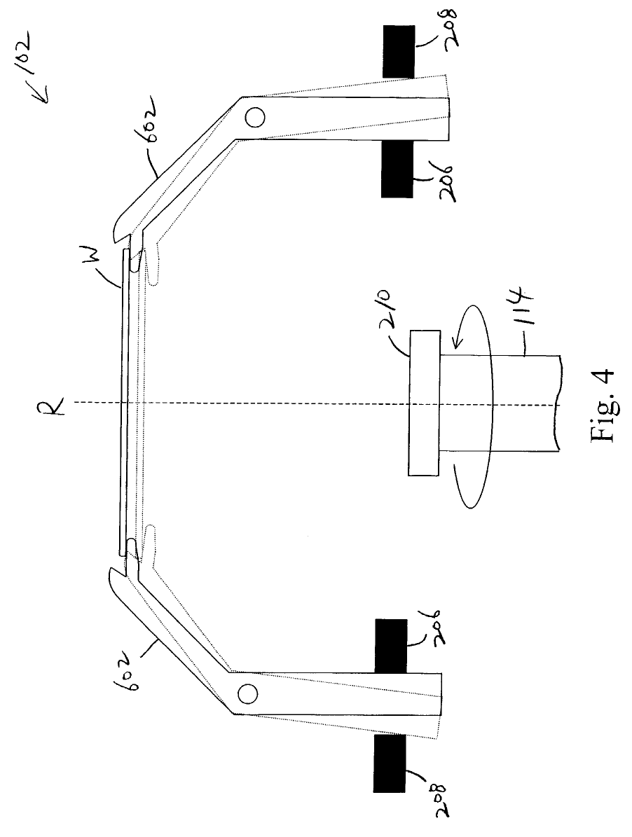

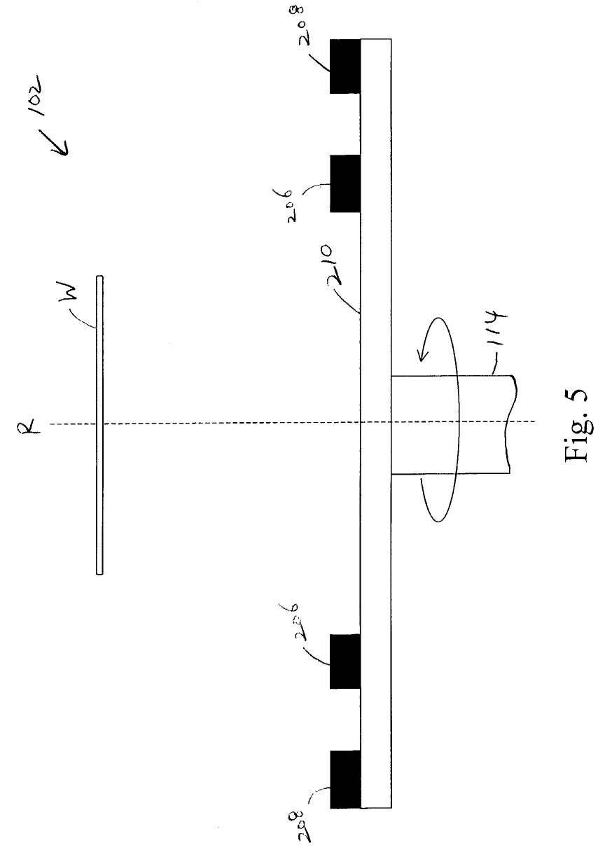

Turning now to FIGS. 2, 3, 4 and 5, the wafer holding apparatus 102 in accordance with the exemplary embodiment is shown in more detail. FIG. 2 is a top view of the wafer holding apparatus 102 with the semiconductor wafer W, while FIG. 3 is the same view of the apparatus without the semiconductor wafer. FIGS. 4 and 5 are cross-sectional views of the apparatus 102 along the A--A and B--B lines shown in FIG. 2, respectively. For ease of illustration, the backside cleaning structure 118 is not shown in FIGS. 2, 3, 4 and 5. As shown in FIGS. 2 and 3, the wafer holding apparatus 102 includes wafer confining assemblies 204a, 204b, 204c and 204d that are mounted on an inner stopper ring 206 and an outer stopper ring 208. Although the wafer holding apparatus 102 is shown in FIGS. 2 and 3 as having four wafer confining assemblies, the wafer holding apparatus may include fewer or more wafer confining assemblies. The inner and outer stopper rings 206 and 208 are attached to a platform 210, which extends across the outer stopper ring. The inner and outer stopper rings 206 and 208 and the platform 210 form a support structure for the wafer holding apparatus 102. As shown in FIGS. 4 and 5, the platform 210 is attached to the rotating shaft 114. Thus, the wafer holding apparatus 102 can be rotated about a rotational axis R, which coincides with the center of the wafer holding apparatus and the center of the semiconductor wafer when the wafer is securely held by the wafer holding apparatus.

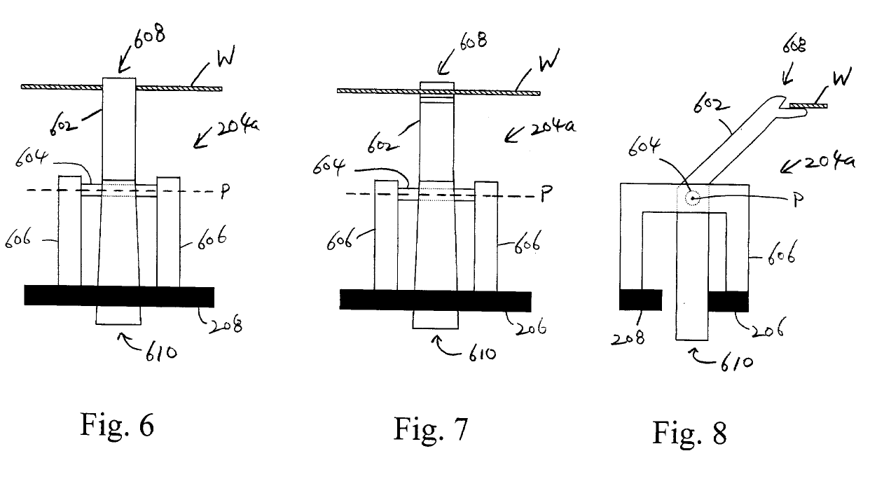

The confining assemblies 204a, 204b, 204c and 204d of the wafer holding apparatus 102 are identical. Thus, only the confining assembly 204a is illustrated and described in detail with reference to FIGS. 6, 7 and 8. FIGS. 6 and 7 illustrate the exterior and interior sides of the confining assembly 204a, respectively, while FIG. 8 illustrates a lateral side of the confining assembly 204a. The interior side of the confining assembly 204a is the side that faces the rotating axis R, while the exterior side is the side that faces away from the rotating axis. The confining assembly 204a includes a confining member 602 with a pivoting pin 604 that extends out of the sides of the confining member. The pivoting pin 604 is operatively connected to a pair of pin support structures 606, which are attached to the inner and outer stopper rings 206 and 208. The pivoting pin 604 allows the confining member 602 to pivot about a pivoting axis P, i.e., the axis of the pivoting pin. The confining member 602 includes a wafer engaging end 608 and a counterbalance end 610. The pivoting axis P is located between the wafer engaging end 608 and the counterbalance end 610 such that, when the wafer holding apparatus 102 is at rest, the confining member 602 is positioned at a wafer receiving position, as illustrated in FIG. 8. However, when the wafer holding apparatus 102 is being rotated, the confining member 602 is pivoted by the centrifugal force caused by rotation of the wafer holding apparatus to a wafer confining position, as illustrated in FIG. 4 by the phantom confining members. When the wafer holding apparatus 102 is no longer being rotated, the confining member 602 is pivoted back to the original wafer receiving position. The inner and outer stopper rings 206 and 208 limit the pivoting movement of the confining member 602, which prevents the confining member from being pivoted too far in either direction. In the exemplary embodiment, the confining member 602 is bent such that the pivoting axis is more distant from the rotational axis than the wafer engaging end 608. However, the confining member 602 can have other configurations.

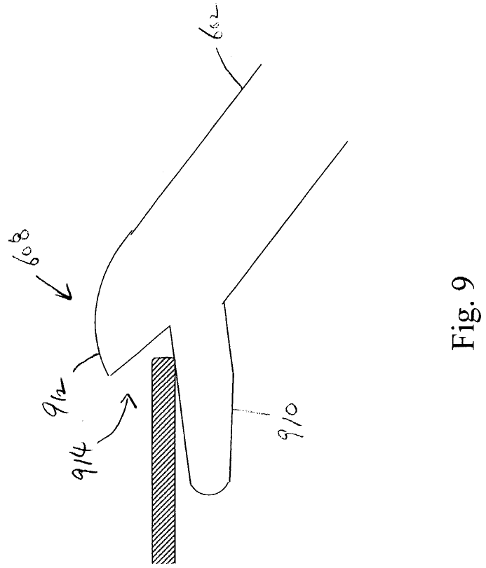

The wafer engaging end 608 of the confining member 602 includes a wafer supporting portion 910 and a wafer confining portion 912, as illustrated in FIG. 9. The wafer supporting portion 910 and the wafer confining portion 912 both protrude from the main body of the confining member 602, forming a concave-like confining region 914. The wafer supporting portion 910 allows the semiconductor wafer W to be supported by the pivotable confining members 602 of the wafer confining assemblies 204a, 204b, 204c and 204d, when the wafer holding apparatus 102 is at rest, as illustrated in FIG. 4. However, when the wafer holding apparatus 102 is being rotated, each of the confining members 602 is pivoted to the wafer confining position such that the concave-like confining region 914 applies pressure on the edge of the semiconductor wafer in a radial direction toward the rotational axis R, thereby securely holding the wafer. In addition to forming the concave-like confining region 914 with the wafer supporting portion 910, the wafer confining portion 912 is configured to partially extend over the semiconductor wafer when the confining member 602 is pivoted to the wafer confining position, as illustrated in FIG. 4. Consequently, when the semiconductor wafer W is being rotated and held by the confining members 602 of the wafer holding apparatus 102, the wafer confining portions 912 of the confining members 602 provide an upward confinement of the wafer so that the wafer is not vertically thrown off the wafer holding apparatus. Similarly, the wafer supporting portion 910 is configured to partially extend under the semiconductor wafer when the confining member 602 is pivoted to the wafer receiving position, as illustrated in FIG. 4. In the exemplary embodiment, the wafer engaging end 608 of the confining member 602 is configured such that the concave-like confining region 914 is V-shaped. However, the wafer engaging end 608 can be configured such that the concave-like confining region 914 is shaped in other comparable configurations.

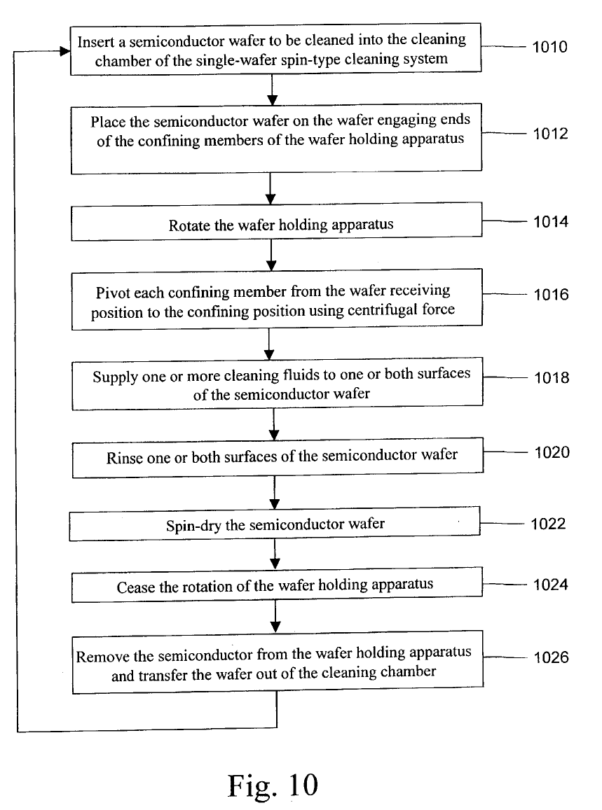

The overall operation of the single-wafer spin-type cleaning system 100 is now described with reference to a flow diagram of FIG. 10. At step 1010, a semiconductor wafer to be cleaned, e.g., the semiconductor wafer W, is inserted into the cleaning chamber 108 using a wafer transferring device (not shown). During this step, the upper enclosure structure 104 is raised so that the cleaning chamber 108 is open to receive the semiconductor wafer. Next, at step 1012, the semiconductor wafer is placed on the wafer engaging ends 608 of the confining members 602 of the wafer holding apparatus 102, which is at rest. Thus, each confining member is positioned at the wafer receiving position. At step 1014, the wafer holding apparatus 102 is rotated by the rotational drive mechanism 116. The rotation of the wafer holding apparatus 102 creates a centrifugal force on the confining members 602. Consequently, at step 1016, each confining member 602 is pivoted from the wafer receiving position to the confining position using the centrifugal force. As a result, the confining members 602 of the wafer holding apparatus 102 applies pressure on the edge of the semiconductor wafer in a radial direction toward the wafer center (the rotational axis R) using the concave-like confining regions 914 of the wafer engaging portions 608 of the confining members 602.

Next, at step 1018, one or more cleaning fluids are supplied to one or both surfaces of the semiconductor wafer, i.e., the front side and the backside of the wafer, through the fluid supply line 120 and/or the fluid supply conduit 122 of the backside cleaning structure 118. During this step, acoustic energy can be generated by the acoustic transducers 118 to apply ultrasonic or megasonic energy to the semiconductor wafer. The sequence of cleaning fluids applied to the semiconductor wafer can vary, depending on the particular wafer cleaning technique being performed. As an example, if RCA wafer cleaning technique is being performed on the front side of the semiconductor wafer, the sequence of cleaning fluids applied to the front side may be as follows: SC1, diluted HF and SC2. Next, at step 1020, one or both surfaces of the semiconductor wafer are rinsed using, for example, deionized water. The semiconductor wafer is then spin-dried, at step 1022. Next, at step 1024, the rotation of the wafer holding apparatus is ceased, which causes each of the confining members to be pivoted back to the wafer receiving position. As an example, the wafer holding apparatus can be stopped by deactivating the rotational drive mechanism 116. At step 1026, the semiconductor is removed from the wafer holding apparatus and transferred out of the cleaning chamber 108. The process then proceeds back to step 1010, and steps 1010-1026 are repeated for the next semiconductor wafer to be processed.

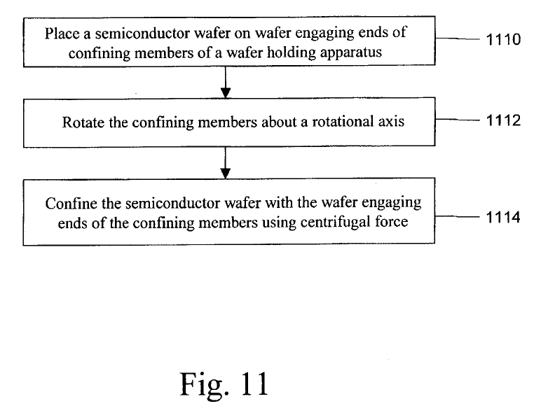

A method of holding a semiconductor wafer in accordance with an exemplary embodiment of the invention is described with reference to a flow diagram of FIG. 11. At step 1110, the semiconductor wafer is placed on wafer engaging ends of confining members of a wafer holding apparatus. Next, at step 1112, the confining members are rotated about a rotational axis. At step 1114, the semiconductor wafer is confined with the wafer engaging ends of the confining members using centrifugal force, which is caused by the rotation of the confining members. In the exemplary embodiment, the confining members are pivoted by the centrifugal force such that the wafer engaging ends of the confining members are moved in a radial direction toward the rotation axis to engage the edge of the semiconductor wafer, applying radial pressure on the wafer edge to securely hold the wafer.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus for holding an object comprising:
a support structure;
a rotational drive mechanism operatively connected to said support structure to rotate said support structure about a rotational axis; and
a plurality of confining assemblies attached to said support structure, each of said confining assemblies including a confining member having an object engaging end that is configured to support said object, said confining member being configured to apply pressure on an edge of said object in a radial direction toward said rotational axis with said object engaging end when subjected to centrifugal force caused by rotation of said support structure.

2. The apparatus of claim 1 wherein said confining member is configured to be pivoted about a pivoting axis when subjected to said centrifugal force such that said object engaging end of said confining member applies said pressure on said edge of said object in said radial direction when said confining member is pivoted.

3. The apparatus of claim 2 wherein said support structure includes outer and inner stopper rings that are designed to restrict pivoting movement of said confining member.

4. The apparatus of claim 1 wherein said confining member is bent such that said pivoting axis is more distant from said rotational axis than said object engaging end.

5. The apparatus of claim 1 wherein said object engaging end of said confining member includes a first protruding portion to support said object when said support structure is at rest.

6. The apparatus of claim 5 wherein said object engaging end of said confining member includes a second protruding portion that forms a confining region with said first protruding portion, said confining region being configured to engage said edge of said object to apply said pressure when said confining member is subjected to said centrifugal force.

7. The apparatus of claim 6 wherein said second protruding portion of said object engaging end is configured to protrude over said object when said pressure is being applied on said edge of said object by said object engaging end.

8. The apparatus of claim 6 wherein said first and second protruding portions of said object engaging end are configured such that said confining region is concave-like shaped.

9. The apparatus of claim 8 wherein said confining region is V-shaped.

10. A method of holding an object comprising:
placing said object on object engaging ends of confining members of an object holding apparatus;
rotating said confining members about a rotational axis; and
confining said object with said object engaging ends of said confining members using centrifugal force caused by rotation of said confining members such that said object is held by said engaging ends of said confining member.

11. The method of claim 10 wherein said confining of said object includes pivoting at least one of said confining members about a pivoting axis using said centrifugal force such at least one of said object engaging ends of said confining members are moved in a radial direction toward said rotational axis.

12. The method of claim 10 wherein said placing of said object includes placing said object on first protruding portions of said object engaging ends.

13. The method of claim 12 wherein said confining of said object includes confining an edge of said object with confining regions of said engaging ends of said confining members, said confining regions being regions defined by said first protruding portions and second protruding portions of said object engaging ends of said confining members.

14. The method of claim 12 wherein said confining regions are concave-like shaped.

15. The method of claim 14 wherein said confining regions are V-shaped.

16. An apparatus for holding an object comprising:
a support structure;
a rotational drive mechanism operatively connected to said support structure to rotate said support structure about a rotational axis; and
a plurality of confining assemblies attached to said support structure, each of said confining assemblies including a confining member having an object engaging end that is configured to support said object, said confining member being pivotable about a pivoting axis when subjected to centrifugal force caused by rotation of said support structure such that pressure is applied to an edge of said object in a radial direction toward said rotational axis by said object engaging end when said confining member is pivoted.

17. The apparatus of claim 16 wherein said object engaging end of said confining member includes a first protruding portion to support said object when said support structure is at rest.

18. The apparatus of claim 17 wherein said object engaging end of said confining member includes a second protruding portion that forms a confining region with said first protruding portion, said confining region being configured to engage said edge of said object when said confining member is pivoted by said centrifugal force.

19. The apparatus of claim 18 wherein said second protruding portion of said object engaging end is configured to protrude over said object when said confining member is pivoted.

20. The apparatus of claim 18 wherein said first and second protruding portions of said object engaging end are configured such that said confining region is concave-like shaped.

21. The apparatus of claim 18 wherein said confining member is bent such that said pivoting axis is more distant from said rotational axis than said object engaging end.

22. The apparatus of claim 18 wherein said support structure includes outer and inner stopper rings that are designed to restrict pivoting movement of said confining member.
